(19) United States
(12) Patent Application Publication
(10) Pub. No.: US 2015/0146038 A1
(43) Pub. Date: May 28, 2015

(54) APPARATUS, SYSTEMS, AND METHODS FOR ADAPTIVE IMAGE PROCESSING

(71) Applicant: Linear Algebra Technologies Limited, Dublin (IE)

(72) Inventor: David DONOHOE, Ontario (CA)

(73) Assignee: LINEAR ALGEBRA TECHNOLOGIES LIMITED, Dublin (IE)

(21) Appl. No.: 14/089,908

(22) Filed: Nov. 26, 2013

(51) Int. Cl. H04N 5/217; H04N 9/73; H04N 5/235; H04N 9/04

(52) U.S. Cl. CPC H04N 5/2173; H04N 9/045; H04N 9/735; H04N 5/2351
USPC 348/225.1; 348/251

(57) ABSTRACT

The disclosed subject matter includes an apparatus configured to remove a shading effect from an image. The apparatus can include one or more interfaces configured to provide communication with an imaging module that is configured to capture the image, and a processor, in communication with the one or more interfaces, configured to run a module stored in memory. The module is configured to receive the image captured by the imaging module under a first lighting spectrum, receive a per-unit correction mesh for adjusting images captured by the imaging module under a second lighting spectrum, determine a correction mesh for the image captured under the first lighting spectrum based on the per-unit correction mesh for the second lighting spectrum, and operate the correction mesh on the image to remove the shading effect from the image.

### FIELD OF THE APPLICATION

The present application relates generally to image processing. In particular, the present application relates to removing shading effects in images.

### BACKGROUND

An image sensor can be used to capture color information about a scene. The image sensor can include pixel elements that are configured to respond differently to different wavelengths of light, much like a human visual system. In many cases, a pixel element of an image sensor can achieve such color selectivity using a color filter, which filters the incoming light reaching the pixel element based on the light's wavelength. For an image sensor with a plurality of pixel elements arranged in an array, the color filters for the plurality of pixel elements can be arranged in an array as well. Such color filters are often referred to as a color filter array (CFA).

There are many types of CFAs. One of the widely used CFAs is a Bayer CFA, which arranges the color filters in an alternating, checkerboard pattern. FIG. 1A illustrates a Bayer CFA. The Bayer CFA 102 can include a plurality of color filters (e.g., Gr 104, R 106, B 108, and Gb 110), each of which filters the incoming light reaching a pixel element based on the light's wavelength. For example, a pixel underlying a green filter 104 can capture light with a wavelength in the range of the color “green”; a pixel underlying a red filter 106 can capture light with a wavelength in the range of the color “red”; and a pixel underlying a blue filter 108 can capture light with a wavelength in the range of the color “blue.” The Bayer CFA 102 can be overlaid on the pixel elements so that the underlying pixel elements only observe the light that passes through the overlaid filter. The Bayer CFA 102 can arrange the color filters in a checkerboard pattern. In the Bayer CFA 102, there are twice as many green filters 104, 110 as there are red filters 106 or blue filters 108. There may be other types of CFAs. Different CFAs differ in (1) the filters used to pass selected wavelengths of light and/or (2) the arrangement of filters in the array.

An image captured by an image sensor with a CFA can be processed to generate a color image. In particular, each color channel (e.g., Red, Green, Blue) can be separated into separate “channels.” As an example, FIG. 1B illustrates the Green channel 120 of the captured image 102. The Green channel 120 includes pixels with missing values 118 because those pixels were used to capture other colors (e.g., Red or Blue). These missing values 118 can be interpolated from neighboring pixels 110, 112, 114, 116 to fill-in the missing value. This process can be repeated for other color channels. By stacking the interpolated color channels, a color image can be generated.

An image captured by an image sensor can be subject to undesired shading effects. The shading effects refer to a phenomenon in which a brightness of an image is reduced. In some cases, the shading effects can vary as a function of a spatial location in an image. One of the prominent spatially-varying shading effects is referred to as the color non-uniformity effect. The color non-uniformity effect refers to a phenomenon in which a color of a captured image varies spatially, even when the physical properties of the light (e.g., the amount of light and/or the wavelength of the captured light) captured by the image sensor is uniform across spatial locations in the image sensor. A typical symptom of a color non-uniformity effect can include a green tint at the center of an image, which fades into a magenta tint towards the edges of an image. This particular symptom has been referred to as the “green spot” issue. The color non-uniformity effect can be prominent when a camera captures an image of white or gray surfaces, such as a wall or a piece of paper.

Another one of the prominent spatially-varying shading effects is referred to as a vignetting effect. The vignetting effect refers to a phenomenon in which less light reaches the corners of an image sensor compared to the center of an image sensor. This results in decreasing brightness as one moves away from the center of an image and towards the edges of the image. FIG. 2 illustrates a typical vignetting effect. When a camera is used to capture an image 200 of a uniform white surface, the vignetting effect can render the corners of the image 202 darker than the center of the image 204.

Because the spatially-varying shading effects can be undesirable, there is a need for an effective, efficient mechanism for removing the spatially-varying shading effects from an image.

### SUMMARY

The disclosed embodiments include an apparatus. The apparatus can be configured to remove a shading effect from an image. The apparatus can include one or more interfaces configured to provide communication with an imaging module that is configured to capture the image; and a processor, in communication with the one or more interfaces, configured to run a module stored in memory. The module can be configured to receive the image captured by the imaging module under a first lighting spectrum; receive a per-unit correction mesh for adjusting images captured by the imaging module under a second lighting spectrum; determine a correction mesh for the image captured under the first lighting spectrum based on the per-unit correction mesh for the second lighting spectrum; and operate the correction mesh on the image to remove the shading effect from the image.

In some embodiments, the module is further configured to determine that the image was captured under the first lighting spectrum using an automated white balance technique.

In some embodiments, the module is further configured to determine the correction mesh for the image based on the first lighting spectrum of the image.

In some embodiments, the module is further configured to determine, using the automated white balance technique, that the first lighting spectrum of the image is substantially similar to one of a predetermined set of lighting spectra, receive a prediction function associated with the one of the predetermined set of lighting spectra, and apply the prediction function to at least a portion of the per-unit correction mesh to determine the correction mesh for the image.

In some embodiments, the prediction function comprises a linear function.

In some embodiments, the prediction function is based on characteristics of image sensors having an identical image sensor type as an image sensor in the imaging module.

In some embodiments, the prediction function is associated only with the portion of the per-unit correction mesh.

In some embodiments, the module is configured to determine, using the automated white balance technique, that the first lighting spectrum of the image is substantially similar to a linear combination of two or more lighting spectra, receive prediction functions associated with the two or more lighting spectra, combine the prediction functions to generate a final prediction function, and apply the final prediction function to at least a portion of the per-unit correction mesh to determine the correction mesh for the image.

In some embodiments, the apparatus is a part of a camera module in a mobile device.

The disclosed embodiments include a method for removing a shading effect on an image. The method can include receiving, at a correction module of a computing system, the image captured under a first lighting spectrum from an imaging module over an interface of the computing system; receiving, at the correction module, a per-unit correction mesh for adjusting images captured by the imaging module under a second lighting spectrum; determining, at the correction module, a correction mesh for the image captured under the first lighting spectrum based on the per-unit correction mesh for the second lighting spectrum; and operating, at the correction module, the correction mesh on the image to remove the shading effect from the image.

In some embodiments, the method further includes determining that the image was captured under the first lighting spectrum using an automated white balance technique.

In some embodiments, the method further includes determining the correction mesh for the image based on the first lighting spectrum of the image.

In some embodiments, the method further includes determining, using the automated white balance technique, that the first lighting spectrum of the image is substantially similar to one of a predetermined set of lighting spectra, receiving a prediction function associated with the one of the predetermined set of lighting spectra, and applying the prediction function to at least a portion of the per-unit correction mesh to determine the correction mesh for the image.

In some embodiments, the prediction function is based on characteristics of image sensors having an identical image sensor type as an image sensor in the imaging module.

In some embodiments, the method further includes determining, using the automated white balance technique, that the first lighting spectrum of the image is substantially similar to a linear combination of two or more lighting spectra, receiving prediction functions associated with the two or more lighting spectra, combining the prediction functions to generate a final prediction function, and applying the final prediction function to at least a portion of the per-unit correction mesh to determine the correction mesh for the image.

The disclosed embodiments include a non-transitory computer readable medium having executable instructions associated with a correction module. The executable instructions are operable to cause a data processing apparatus to an image captured under a first lighting spectrum from an imaging module in communication with the data processing apparatus; retrieve, from a memory device, a per-unit correction mesh for adjusting images captured by the imaging module under a second lighting spectrum; determine a correction mesh for the image captured under the first lighting spectrum based on the per-unit correction mesh for the second lighting spectrum; and operate the correction mesh on the image to remove a shading effect from the image.

In some embodiments, the computer readable medium further includes executable instructions operable to cause the data processing apparatus to determine that the image was captured under the first lighting spectrum using an automated white balance technique.

In some embodiments, the computer readable medium further includes executable instructions operable to cause the data processing apparatus to determine the correction mesh for the image based on the first lighting spectrum of the image.

In some embodiments, the computer readable medium further includes executable instructions operable to cause the data processing apparatus to receive a prediction function associated with one of a predetermined set of lighting spectra, and apply the prediction function to at least a portion of the per-unit correction mesh to determine the correction mesh for the image.

In some embodiments, the prediction function is based on characteristics of image sensors having an identical image sensor type as an image sensor in the imaging module.

The disclosed embodiments include an apparatus. The apparatus is configured to determine a prediction function associated with a first lighting spectrum for a portion of a particular image sensor based on image sensors having an identical image sensor type as the particular image sensor. The apparatus includes a processor configured to run one or more modules stored in memory that is configured to receive portions of a plurality of images associated with the first lighting spectrum taken by a first plurality of image sensors having the identical image sensor type as the particular image sensor; combine the portions of the plurality of images to generate a combined image portion for the first lighting spectrum; determine a first correction mesh for the first lighting spectrum based on the combined image portion for the first lighting spectrum; receive a plurality of correction meshes associated with a second lighting spectrum for a second plurality of image sensors; and determine the prediction function, for the portion of the particular image sensor, that models a relationship between the first correction mesh associated with the first lighting spectrum and the plurality of correction meshes associated with the second lighting spectrum, thereby providing the prediction function for the particular image sensor without relying on any images taken by the particular image sensor.

In some embodiments, the one or more modules is configured to minimize, in part, a sum of squared differences between values of the first correction mesh associated with the first lighting spectrum and values of the plurality of correction meshes associated with the second lighting spectrum.

In some embodiments, the prediction function comprises a linear function.

In some embodiments, the one or more modules is configured to provide the prediction function to an imaging module that embodies the particular image sensor.

In some embodiments, the first plurality of image sensors and the second plurality of image sensors comprise an identical set of image sensors.

In some embodiments, the portions of the plurality of images comprises a single pixel of the plurality of images at an identical location in the plurality of images.

In some embodiments, the one or more modules is configured to communicate with a correction module, which is configured to: receive an image from the particular image sensor; retrieve a per-unit correction mesh associated with the particular image sensor, wherein the per-unit correction mesh is associated with the second lighting spectrum; determine a correction mesh for a portion of the image by operating the prediction function on a portion of the per-unit correction mesh; and operate the correction mesh on a portion of the image to remove a shading effect from the portion of the image.

In some embodiments, the apparatus is a part of a mobile device.

The disclosed embodiments include a method for determining a prediction function associated with a first lighting spectrum for a portion of a particular image sensor based on image sensors having an identical image sensor type as the particular image sensor. The method can include receiving, at a sensor type calibration module of an apparatus, portions of a plurality of images associated with the first lighting spectrum taken by a first plurality of image sensors having the identical image sensor type as the particular image sensor; combining, by the sensor type calibration module, the portions of the plurality of images to generate a combined image portion for the first lighting spectrum; determining, by the sensor type calibration module, a first correction mesh for the first lighting spectrum based on the combined image portion for the first lighting spectrum; receiving, at a prediction function estimation module in the apparatus, a plurality of correction meshes associated with a second lighting spectrum for a second plurality of image sensors; and determining, by the prediction function estimation module, the prediction function, for the portion of the particular image sensor, that models a relationship between the first correction mesh associated with the first lighting spectrum and the plurality of correction meshes associated with the second lighting spectrum, thereby providing the prediction function for the particular image sensor without relying on any images taken by the particular image sensor.

In some embodiments, determining the prediction function comprises minimizing, in part, a sum of squared differences between the first correction mesh associated with the first lighting spectrum and the plurality of correction meshes associated with the second lighting spectrum.

In some embodiments, the prediction function comprises a linear function.

In some embodiments, the method includes providing, by the prediction function estimation module, the prediction function to an imaging module that embodies the particular image sensor.

In some embodiments, the first plurality of image sensors and the second plurality of image sensors comprise an identical set of image sensors.

In some embodiments, the portions of the plurality of images comprises a single pixel of the plurality of images at an identical grid location in the plurality of images.

In some embodiments, the method includes receiving, at a correction module in communication with the particular image sensor, an image from the particular image sensor; retrieving, by the correction module, a per-unit correction mesh associated with the particular image sensor, wherein the per-unit correction mesh is associated with the second lighting spectrum; determining, by the correction module, a correction mesh for a portion of the image by operating the prediction function on a portion of the per-unit correction mesh; and operating, by the correction module, the correction mesh on a portion of the image to remove a shading effect from the portion of the image.

The disclosed embodiments include a non-transitory computer readable medium having executable instructions operable to cause a data processing apparatus to determine a prediction function associated with a first lighting spectrum for a portion of a particular image sensor based on image sensors having an identical image sensor type as the particular image sensor. The executable instructions can be operable to cause the data processing apparatus to receive portions of a plurality of images associated with the first lighting spectrum taken by a first plurality of image sensors having the identical image sensor type as the particular image sensor; combine the portions of the plurality of images to generate a combined image portion for the first lighting spectrum; determine a first correction mesh for the first lighting spectrum based on the combined image portion for the first lighting spectrum; receive a plurality of correction meshes associated with a second lighting spectrum for a second plurality of image sensors; and determine the prediction function, for the portion of the particular image sensor, that models a relationship between the first correction mesh associated with the first lighting spectrum and the plurality of correction meshes associated with the second lighting spectrum, thereby providing the prediction function for the particular image sensor without relying on any images taken by the particular image sensor.

In some embodiments, the computer readable medium can also include executable instructions operable to cause the data processing apparatus to minimize, in part, a sum of squared differences between the first correction mesh associated with the first lighting spectrum and the plurality of correction meshes associated with the second lighting spectrum.

In some embodiments, the computer readable medium can also include executable instructions operable to cause the data processing apparatus to provide the prediction function to an imaging module that embodies the particular image sensor.

In some embodiments, the portions of the plurality of images comprises a single pixel of the plurality of images at an identical grid location in the plurality of images.

In some embodiments, the computer readable medium can also include executable instructions operable to cause the data processing apparatus to communicate with a correction module, which is configured to: receive an image from the particular image sensor; retrieve a per-unit correction mesh associated with the particular image sensor, wherein the per-unit correction mesh is associated with the second lighting spectrum; determine a correction mesh for a portion of the image by operating the prediction function on a portion of the per-unit correction mesh; and operate the correction mesh on a portion of the image to remove a shading effect from the portion of the image.

### DESCRIPTION OF DRAWINGS

Various objects, features, and advantages of the disclosed subject matter can be more fully appreciated with reference to the following detailed description of the disclosed subject matter when considered in connection with the following drawings, in which like reference numerals identify like elements.

FIGS. 1A-1B illustrate a Bayer color filter array and an interpolation technique for generating a color image.

FIG. 2 illustrates a typical vignetting effect.

FIG. 3 illustrates an imaging system that corrects a shading effect in an image in accordance with some embodiments.

FIG. 4 illustrates a correction mesh estimation process during a training stage in accordance with some embodiments.

FIG. 5 illustrates a shading correction process during a run-time stage in accordance with some embodiments.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems and methods that are within the scope of the disclosed subject matter.

Removing spatially-variant shading effects from an image is a challenging task because the strength of the spatially-variant shading effects can depend on an individual camera's characteristics. For example, the strength of a vignetting effect can depend on the mechanical and optical design of a camera. As another example, the strength of a color non-uniformity effect can depend on an individual image sensor's characteristics such as a geometry of pixels in an image sensor.

The color non-uniformity effect can be particularly pronounced in image sensors for mobile devices, such as a cellular phone. In mobile devices, there is a need to keep the size of the image sensor to a small form factor while retaining a high pixel resolution. This results in very small pixel geometries (on the order of 1.7 μm), which can be detrimental to the color non-uniformity effect.

One of the reasons that small pixels increase the color non-uniformity effect is that a small pixel geometry can increase the crosstalk of color channels in an image sensor. Crosstalk refers to a phenomenon in which the light passing through a given “tile” (e.g., pixel) of the CFA is not registered (or accumulated) solely by the pixel element underneath it, but also contributes to the surrounding sensor elements, thereby increasing the value of the neighboring pixels for different colors.

Traditionally, crosstalk was not a big problem because it could be corrected using a global color correction matrix, which removes the crosstalk effect globally (e.g., uniformly) across the image. However, as the pixel geometry gets smaller, spatially-varying crosstalk has become more prominent. With smaller pixels, the crosstalk effect is more prominent at the edge of an image sensor because more light reaches the edge of an image sensor at an oblique angle. This results in a strong, spatially-varying color shift. Such spatially-varying crosstalk effects are hard to remove because the spatially varying crosstalk effect is not always aligned with the center of the image, nor is it perfectly radial. Therefore, it is hard to precisely model the shape in which the spatially-varying crosstalk effect is manifested.

In addition, the crosstalk pattern can vary significantly from one image sensor to another due to manufacturing process variations. Oftentimes, the crosstalk pattern can depend heavily on the optical filters placed in front of the image sensor, such as an infrared (IR) cutoff filter. Moreover, the crosstalk effect can depend on the spectral power distribution (SPD) of the light reaching the image sensor. For example, an image of a white paper captured under sunlight provides a completely different color shift compared to an image of the same white paper captured under fluorescent light. Therefore, removing spatially-varying, sensor-dependent shading, resulting from crosstalk effects or vignetting effects, is a challenging task.

One approach to removing the spatially-varying, sensor-dependent shading from an image is (1) determining a gain factor that should be applied to each pixel in the image to “un-do” (or compensate for) the shading effect of the image sensor and (2) multiplying each pixel of the image with the corresponding gain factor. However, because the gain factor for each pixel would depend on (1) an individual sensor's characteristics and (2) the lighting profile under which the image was taken, the gain factor should be determined for every pixel in the image, for all sensors of interest, and for all lighting conditions of interest. Therefore, this process can be time consuming and inefficient.

The disclosed apparatus, systems, and methods relate to effectively removing sensor-dependent, lighting-dependent shading effects from images. The disclosed shading removal mechanism does not make any assumptions about the spatial pattern in which shading effects are manifested in images. For example, the disclosed shading removal mechanism does not assume that the shading effects follow a radial pattern or a polynomial pattern. The disclosed shading removal mechanism avoids predetermining the spatial pattern of the shading effects to retain high flexibility and versatility.

The disclosed shading removal mechanism is configured to model shading characteristics of an image sensor so that shading effects from images, captured by the image sensor, can be removed using the modeled shading characteristics. The disclosed shading removal mechanism can model the shading characteristics of an image sensor using a correction mesh. The correction mesh can include one or more parameters with which an image can be processed to remove the shading effects.

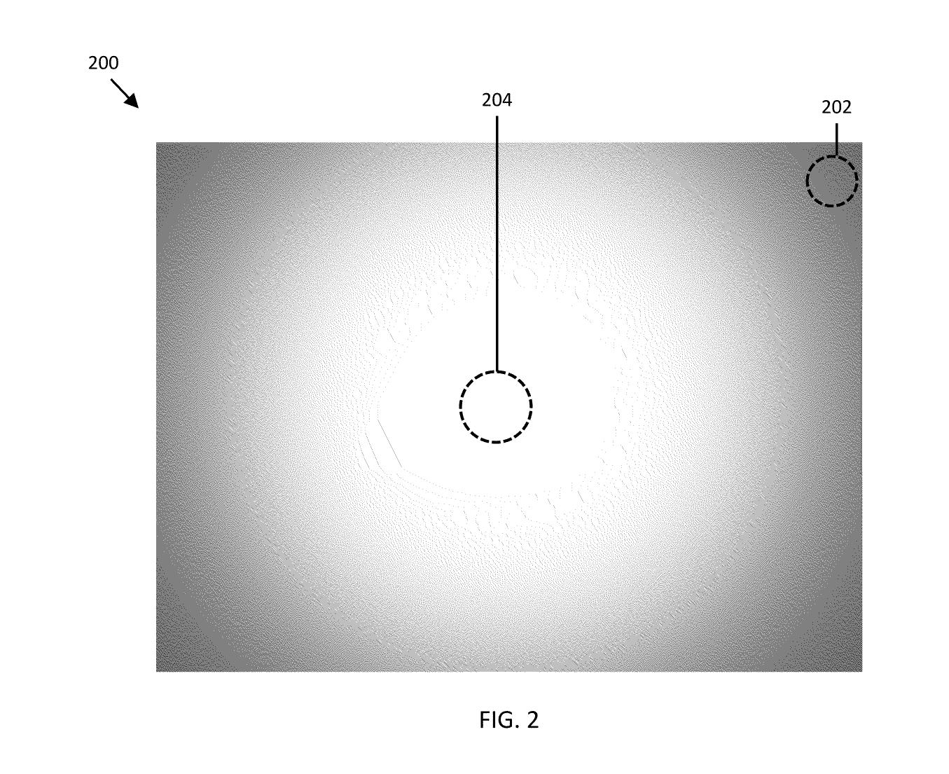

In some embodiments, the correction mesh can include one or more gain factors to be multiplied to one or more pixel values in an image in order to compensate for the shading effect. For example, when the correction mesh models a vignetting effect, as illustrated in FIG. 2, the correction mesh can have unit value (e.g., a value of “1”) near the center of the correction mesh since there is not any shading effect to remove at the center. However, the correction mesh can have a larger value (e.g., a value of “5”) near the corners because the shading effect is more prominent in the corners and the pixel values at the corner need to be amplified to counteract the shading effect. In some cases, the correction mesh can have the same spatial dimensionality as the image sensor. For example, when the image sensor has N×M pixels, the correction mesh can also have N×M pixels. In other cases, the correction mesh can have a lower spatial dimensionality compared to the image sensor. Because the shading can vary slowly across the image, the correction mesh does not need to have the same resolution as the image sensor to fully compensate for the shading effect. Instead, the correction mesh can have a lower spatial dimensionality compared to the image sensor so that the correction mesh can be stored in a storage medium with a limited capacity, and can be up-sampled prior to being applied to correct the shading effect.

In some embodiments, the correction mesh can be determined based on an image of a highly uniform scene captured using an image sensor of interest. When the image sensor does not suffer from any shading effects, the captured image of a highly uniform scene should be a uniform image, having the same pixel value everywhere across the image. However, when the image sensor suffers from shading effects, the captured image of a highly uniform scene is not uniform. Therefore, the captured image of a highly uniform scene can be used to determine signal gain factors to remove the shading effect. In some cases, the highly uniform scene can be a smooth white surface; in other cases, the highly uniform scene can be a light field output by an integrating sphere that can provide uniform light rays.

In some embodiments, the correction mesh can be generated by inverting the value of each pixel of the captured highly uniform scene image:

$$C ( x , y ) = \frac{1}{I ( x , y )}$$

where (x,y) represents a coordinate of the pixel; I(x,y) represents a pixel value of the white surface image captured by the image sensor at position (x,y); and C(x,y) represents a value of the correction mesh at position at position (x,y). In some cases, the captured image can be filtered using a low-pass filter, such as a Gaussian filter, before being inverted:

$$C ( x , y ) = \frac{1}{G ( x , y ) ⊗ I ( x , y )}$$

where G(x,y) is a low-pass filter and [symbol] is a convolution operator. In some embodiments, the Gaussian filter can be 7×7 pixels. This filtering step can be beneficial when the image sensor is noisy. When the correction filter C(x,y) is designed to have a lower resolution compared to the image sensor, the correction filter C(x,y) can be computed by inverting a sub-sampled version of the low-pass filtered image:

$$C ( w , z ) = \frac{1}{↓ ( G ( x , y ) ⊗ I ( x , y ) )}$$

where ↓(•) indicates a down-sampling operator, and (w,z) refers to the down-sampled coordinate system. The subsampling operation can saves memory and bandwidth at runtime. In some embodiments, it is desirable to reduce the size of the correction mesh for memory and bandwidth benefits, but it should be large enough to avoid artifacts when it is up-sampled to the image resolution at run-time.

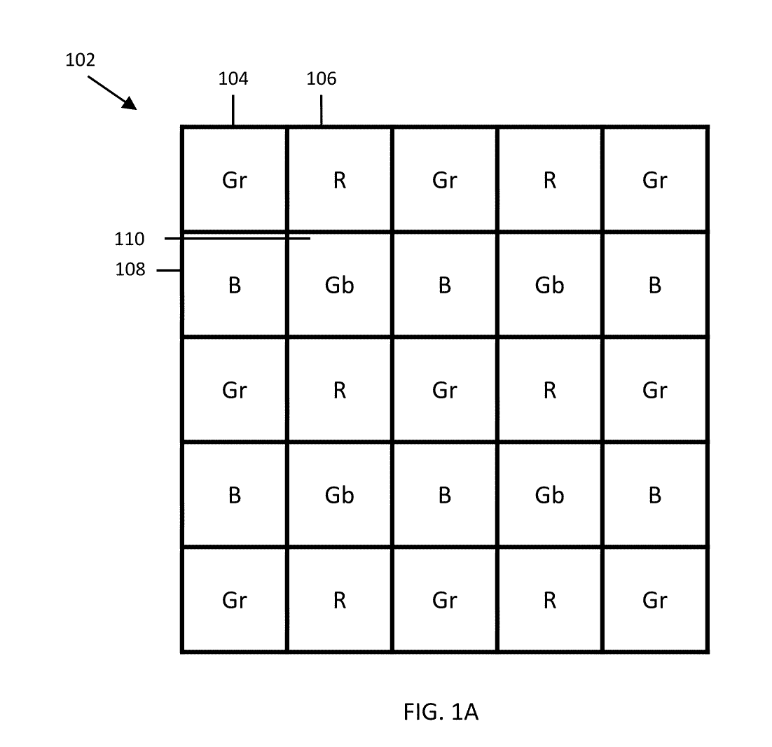

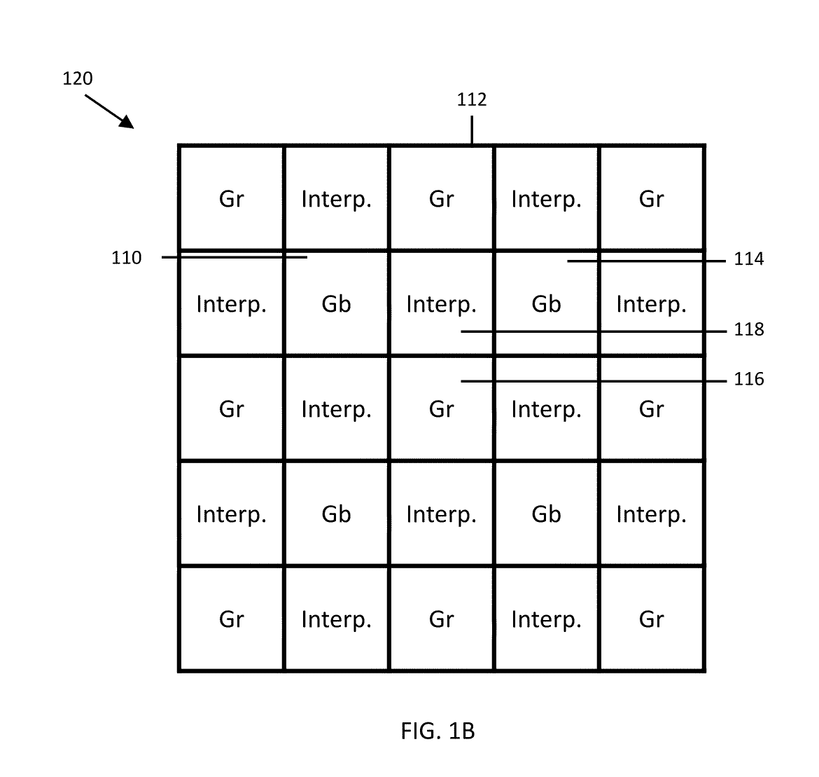

In some embodiments, each color channel of an image sensor can have its own separate correction mesh. This allows the disclosed shading correction mechanism to address not only intensity shading effects, but also color shading effects, such as the color non-uniformity. In some cases, when the CFA of the image sensor includes red 106, green 104, and blue 108 pixels, as illustrated in FIG. 1, the shading correction mechanism can use four correction meshes, one correction mesh for the red color channel, referred to as C_{R}, one correction mesh for the blue color channel, referred to as C_{B}, one correction mesh for the green color pixels (Gr) 104 that are laterally adjacent to red pixels, referred to as C_{Gr}, and one correction mesh for the green color pixels (Gb) 110 that are laterally adjacent to blue pixels, referred to as C_{Gb}. Since the amount of crosstalk can be dependent on the angle at which the light arrives at the image sensor, the level of crosstalk between Gr 104 and red 106 or blue 108 pixels is not the same as the level of crosstalk between Gb 110 and red 106 or blue 108 pixels, at a given local area of the sensor. Therefore, it can be beneficial to use four correction meshes for an image sensor with a three-color (RGB) CFA.

In some cases, the amount of shading effects can be dependent on the light spectrum under which an image was taken. Therefore, in some embodiments, the correction meshes can be dependent on an input light spectrum it, also referred to as an input light profile. Such spectrum-dependent correction meshes can be referred to as C_{R,π}(x,y), C_{B,π}(x,y), C_{Gr,π}(x,y), and C_{Gb,π}(x,y) to denote the dependence with the spectrum, π.

Because the correction mesh is dependent on both (1) the image sensor and (2) the input light spectrum, this approach would involve determining the correction mesh for each image sensor for all input light spectra, independently. This process can quickly become unwieldy when there are many image sensors of interest and when the image sensors are expected to operate in a wide-range of input light spectrum. For example, when an image sensor manufacturer or an electronic system manufacturer sells a large number of image sensors, it would be hard to determine a correction mesh for each of the image sensors across all light spectrum of interest. Even if the manufacturers can determine correction meshes for all light spectra of interest, the correction meshes should be stored on the device that would perform the actual shading correction. If the actual shading correction is performed on computing devices with limited memory resources, such as mobile devices or cellular phones, storing such a large number of correction meshes can be, by itself, a challenging and expensive task.

To address these issues, the disclosed shading correction mechanism avoids computing and storing such large number of correction meshes. Instead, the disclosed shading correction mechanism uses a computational technique to predict an appropriate correction mesh for an image captured by a particular image sensor. For example, the disclosed shading correction mechanism can analyze the captured image to determine an input lighting spectrum associated with the captured image. The input lighting spectrum can refer to a lighting profile of a light source used to shine the scene captured by the image. Subsequently, the disclosed shading correction mechanism can estimate an appropriate correction mesh for the determined input lighting spectrum based on (1) known characteristics about the particular image sensor with which the image was captured and (2) typical characteristics of image sensors having the same image sensor type as the particular image sensor.

The known characteristics about the particular image sensor can include a correction mesh of the particular image sensor for a predetermined input light spectrum, which may be different from the determined input lighting spectrum for the captured image. The typical characteristics of image sensors having the same image sensor type can include one or more correction meshes of typical image sensors of the image sensor type with which the particular image sensor is also associated. For example, the typical characteristics of image sensors having the same image sensor type can include one or more correction meshes associated with an “average” image sensor of the image sensor type for a predetermined set of input light spectra, which may or may not include the determined input lighting spectrum for the captured image.

More particularly, the disclosed shading correction mechanism can be configured to predict the correction mesh of the particular image sensor for the determined input lighting spectrum by converting the correction mesh of the particular image sensor for a predetermined input light spectrum (which may be distinct from the determined input light spectrum of the captured image) into a correction mesh for the determined input light spectrum by taking into account the correction meshes associated with an “average” image sensor of the image sensor type.

For example, the disclosed shading correction mechanism is configured to compute the following:

C̅_{i,π}_{_{D}}=ƒ_{π}_{_{D}}(C_{i,π}_{ₚ})

where C_{i,π}_{ₚ} refers to a correction mesh of a sensor i for the predetermined spectrum πₚ, C̅_{i,π}_{_{D}} refers to a predicted correction mesh of the sensor i for the light spectrum π_{D} associated with the input image, and ƒ_{π}_{_{D}} is a prediction function to convert C_{i,π}_{ₚ} to C_{i,π}_{_{D}}. This function ƒ_{π}_{ₚ} can depend on the determined light spectrum π_{D} of the input image—hence the subscript π_{D}—and the image sensor type associated with the sensor i.

This shading correction scheme is useful and efficient because the shading correction scheme can determine the correction mesh C_{i,π}_{ₚ} of the particular sensor i only once for a predetermined spectrum πₚ, and adapt it to be applicable to a wide range of lighting profiles π_{D} using the prediction function ƒ_{π}_{_{D}}. This scheme can reduce the number of correction meshes to be determined for a particular imaging module 302, thereby improving the efficiency of the shading correction. Furthermore, the disclosed shading correction scheme may not require storing all correction meshes for all lighting spectra of interest, which can be expensive.

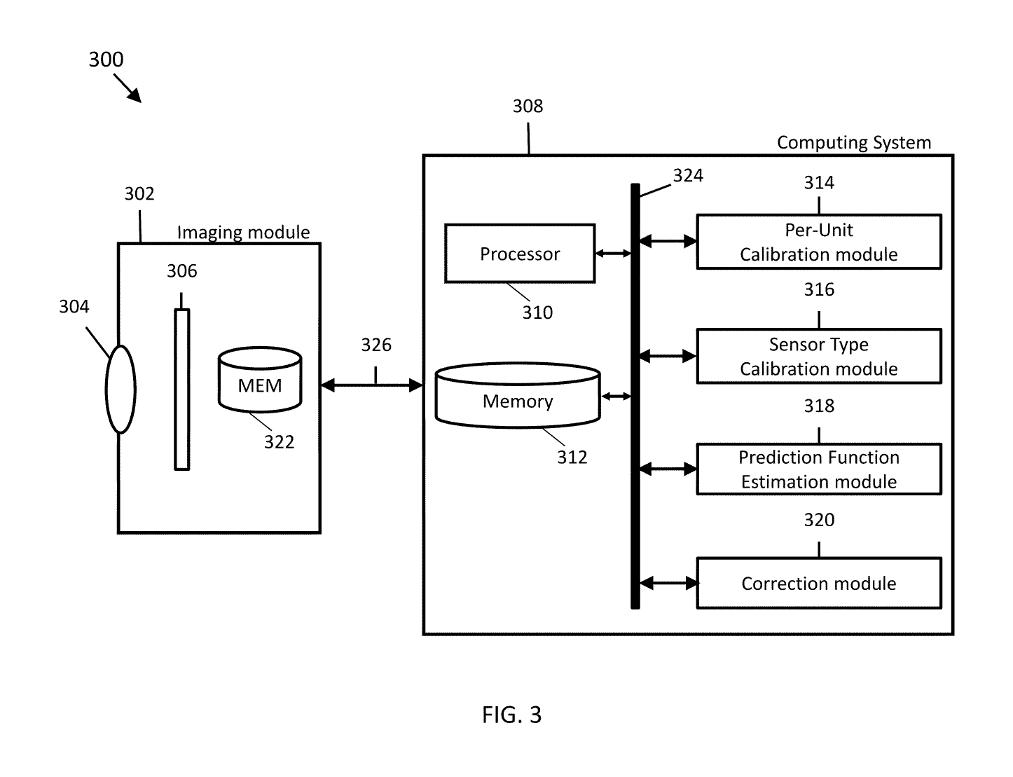

FIG. 3 illustrates an imaging system 300 that carries out the disclosed shading correction scheme in accordance with some embodiments. The imaging system 300 can include an imaging module 302, which can include one or more of a lens 304, an image sensor 306, and/or an internal imaging module memory device 322. The imaging system 300 can also include a computing system 308, which can include one or more of a processor 310, a memory device 312, a per-unit calibration module 314, a sensor type calibration module 316, a correction module 320, an internal interface 324 and/or one or more interfaces 326.

The lens 304 can include an optical device that is configured to collect light rays, from an imaging scene entering the imaging module 302 and form an image of the imaging scene on an image sensor 306. The image sensor 306 can include an electronic device that is configured to convert light rays into electronic signals. The image sensor 306 can include one or more of a digital charge-coupled device (CCD) or complementary metal-oxide-semiconductor (CMOS) pixel elements, also referred to as pixel sensors.

In some embodiments, the internal image module memory device 322 can include a computer readable medium, flash memory, a magnetic disk drive, an optical drive, a programmable read-only memory (PROM), a read-only memory (ROM), or any other suitable memory or combination of memories. The internal image module memory device 322 can be configured to maintain or store a per-unit correction mesh for the imaging module 302, as described further below.

The imaging module 302 can be coupled to a computing device 308 over an interface 326. The memory device 312 of the computing device 308 can include a computer readable medium, flash memory, a magnetic disk drive, an optical drive, a programmable read-only memory (PROM), a read-only memory (ROM), or any other suitable memory or combination of memories. The memory 312 can maintain or store software and/or instructions that can be processed by the processor 310. In some embodiments, the memory 312 can also maintain correction meshes and/or parameters for the prediction function.

The processor 310 can communicate with the memory 312 and interface 326 to communicate with other devices, such as an imaging module 302 or any other computing devices, such as a desktop computer or a server in a data center. The processor 310 can include any applicable processor such as a system-on-a-chip that combines one or more of a central processing unit (CPU), an application processor, and flash memory, or a reduced instruction set computing (RISC) processor.

The interface 326 can provide an input and/or output mechanism to communicate with other network devices. The interface can be implemented in hardware to send and receive signals in a variety of mediums, such as optical, copper, and wireless, and in a number of different protocols, some of which may be non-transient.

The processor 310 can be configured to run one or more modules. The one or more modules can include the per-unit calibration module 314 configured to determine a correction mesh for the image sensor 306 for a specific lighting profile. The one or more modules can also include a sensor type calibration module 316 configured to determine one or more correction meshes for typical image sensors of the same type as the particular image sensor 306 for a predetermined set of lighting spectra. The one or more modules can also include a prediction function estimation module 318 configured to estimate the prediction function for the image sensor 306. The one or more modules can also include the correction module 320 that is configured to apply the predicted correction mesh to remove the shading effect in images captured by the image sensor 306. The one or more modules can include any other suitable module or combination of modules. Although modules 314, 316, 318, and 320 are described as separate modules, they may be combined in any suitable combination of modules. In some embodiments, the processor 310, the memory device 312, and the module 314, 316, 318, 320 can communicate via an internal interface 324.

The disclosed shading correction mechanism can operate in two stages: a training stage and a run-time stage. In the training stage, which may be performed during the device production and/or at a laboratory, the disclosed shading correction mechanism can determine a computational function that is capable of generating a correction mesh for an image sensor of interest. In some cases, the computational function can be determined based on characteristics of image sensors that are similar to the image sensor of interest. Then, in the run-time stage, during which the image sensor of interest takes an image, the disclosed shading correction mechanism can estimate the lighting condition under which the image was taken, use the computational function corresponding to the estimated lighting condition to estimate a correction mesh for the image, and apply the estimated correction mesh to remove shading effects from the image.

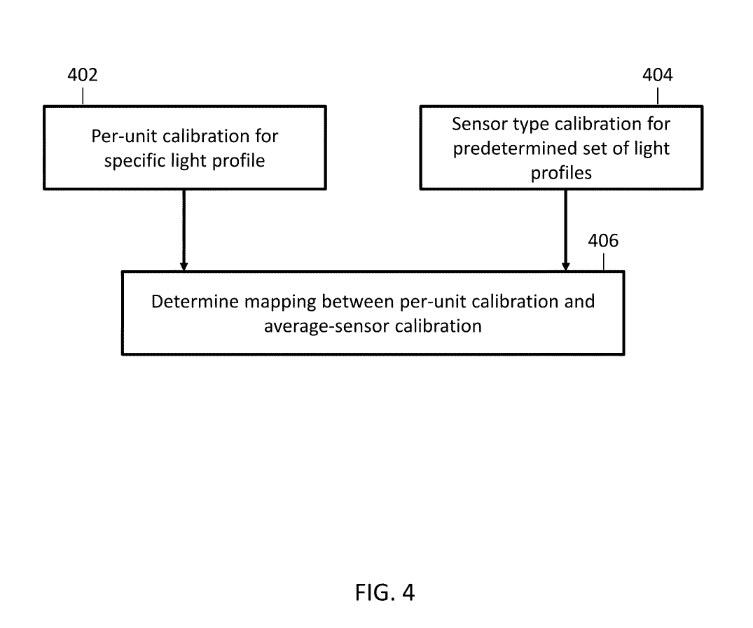

FIG. 4 illustrates a correction mesh estimation process during a training stage in accordance with some embodiments. In step 402, the per-unit (PU) calibration module 314 can be configured to determine a correction mesh for the imaging module 302 for a specific input light spectrum πₚ. In some embodiments, the specific light spectrum πₚ can be predetermined. For example, the specific light spectrum πₚ can be a continuous light spectrum, for instance, a lighting spectrum corresponding to an outdoor scene in the shadow under a daylight, an outdoor scene under a cloudy daylight, an outdoor scene under a direct sunlight, or an incandescent light. As another example, the specific light spectrum πₚ can have a spiky profile, for instance, fluorescent lighting spectrum. In some embodiments, the specific light spectrum πₚ can be one of the examples provided above. In other embodiments, the specific light spectrum πₚ can include two or more of the examples provided above. The correction mesh for the specific light spectrum πₚ can be referred to as a per-unit correction mesh, identified as C_{i,π}_{ₚ}.

The PU calibration module 314 can determine the per-unit correction mesh C_{i,π}_{ₚ} based on a general correction mesh generation procedure described above. For example, the PU calibration module 314 can receive an image I_{i,π}_{ₚ}(x,y) of a uniform, monochromatic surface from the image sensor 306, where the image I_{i,π}_{ₚ}(x,y) is captured under the predetermined specific light profile πₚ. Then the PU calibration module 314 can optionally filter the image I_{i,π}_{ₚ}(x,y) using a low-pass filter, such as a Gaussian filter G(x,y), to generate a filtered image G(x,y) [symbol] I_{i,π}_{ₚ}(x,y). Subsequently, the calibration module 314 can optionally down-sample the filtered image G(x,y) [symbol] I_{i,π}_{ₚ}(x,y) and compute a pixel-wise inverse of the down-sampled, filtered image to generate a per-unit correction mesh C_{i,π}_{ₚ}:

$${C}_{i , {π}_{p}} ( w , z ) = \frac{1}{↓ ( G ( x , y ) ⊗ {I}_{i , {π}_{p}} ( x , y ) )}$$

In some embodiments, when the image of the uniform surface is a color image, then the PU calibration module 314 can stack four adjacent pixels in a 2×2 grid, e.g., Gr 104, R 106, B 108, Gb 110, of the image I_{i,π}_{ₚ} (x,y) to form a single pixel, thereby reducing the size of the image into a quarter. The stacked, four-dimensional image is referred to as a stacked input image I_{i,π}_{ₚ}(x,y), where each pixel has four values. The PU calibration module 314 can then perform the above process to compute a four-dimensional correction mesh C_{i,π}_{ₚ}(w,z), where each dimension is associated with one of the Gr channel, R channel, B channel, and Gb channel:

$${C}_{i , {π}_{p}} ( w , z ) = \frac{1}{↓ ( G ( x , y ) ⊗ {I}_{i , {π}_{p}} ( x , y ) )}$$

In some embodiments, the correction mesh C_{i,π}_{ₚ}(w,z), which refers to [C_{Gr,π}_{ₚ}(w,z), C_{R,π}_{ₚ}(w,z), C_{B,π}_{ₚ}(w,z), and C_{Gb,π}_{ₚ}(w,z)], can be stored in the internal image module memory device 322 and/or a memory device 312.

In some cases, the per-unit correction mesh C_{i,π}_{ₚ}(w,z) can be computed at production time. For example, if the imaging module 302 includes a memory device 322, the imaging module manufacturer can use the PU calibration module 314 to compute the per-unit correction mesh C_{i,π}_{ₚ}(w,z) and store the per-unit correction mesh C_{i,π}_{ₚ}(w,z) in the memory device 322.

In other cases, if the imaging module 302 does not include a memory device 322, the PU calibration module 314 can compute the per-unit correction mesh C_{i,π}_{ₚ}(w,z) when the manufacturer of an electronic system that embodies the imaging module 302 builds the electronic system. For example, when the imaging module 302 is embodied in a cell phone, the manufacturer of the cell phone can use the PU calibration module 314 to compute the per-unit correction mesh C_{i,π}_{ₚ}(w,z) and store the per-unit correction mesh C_{i,π}_{ₚ}(w,z) in the cell phone's memory.

In other cases, the PU calibration module 314 can compute the per-unit correction mesh C_{i,π}_{ₚ}(w,z) by a user of the imaging module 302. For example, the user of the imaging module 302 or an electronic device can be requested to take an image of a uniform surface before the user actually starts to use the imaging module 302. Then the PU calibration module 314 can use the image of the uniform surface to compute the per-unit correction mesh C_{i,π}_{ₚ}(w,z) before the user actually starts to using the imaging module 302.

Because the per-unit correction mesh C_{i,π}_{ₚ}(w,z) is tailored to the particular image sensor 306 for the specific lighting profile πₚ, the per-unit correction mesh C_{i,π}_{ₚ}(w,z) can remove the shading effects only of the particular image sensor 306 and only for the particular lighting profile πₚ. Therefore, the direct use of the per-unit correction mesh C_{i,πp}(w,z) is quite limiting.

In some embodiments, an imaging module manufacturer or an electronic device manufacturer can gather many per-unit correction meshes C_{i,π}_{ₚ}(w,z) for typical image sensors of an image sensor type. The gathered per-unit correction meshes can be used by the prediction function (PF) estimation module 318 to generate a prediction function, as described with respect to step 404.

In step 404, the sensor type (ST) calibration module 316 can generate one or more correction meshes for the image sensor type to which the image sensor 306 belongs. In particular, the ST calibration module 316 can characterize the shading characteristics of an image sensor that is typical of the image sensor type to which the image sensor 306 belongs. In some embodiments, the image sensor type can be defined as a particular product number assigned to the image sensor. In other embodiments, the image sensor type can be defined as a manufacturer of the image sensor. For example, all image sensors manufactured by the same sensor manufacturer can belong to the same image sensor type. In other embodiments, the image sensor type can be defined as a particular fabrication facility from which an image sensor is fabricated. For example, all image sensors manufactured from the same fabrication facility can belong to the same image sensor type. In other embodiments, the image sensor type can be defined as a particular technology used in the image sensor. For example, the image sensor can be a charge-coupled-device (CCD) type or a complementary metal-oxide-semiconductor(CMOS) type depending on the technology used by a pixel element of an image sensor.

The ST calibration module 316 is configured to generate one or more correction meshes for the image sensor type by averaging characteristics of representative image sensors associated with the image sensor type. For example, the ST calibration module 316 is configured to receive images I_{π}_{_{c}}_{εΠ}(x,y) of a uniform, monochromatic surface taken by a set of image sensors that are representative of an image sensor associated with an image sensor type. These images I_{π}_{_{c}}_{εΠ}(x,y) are taken under one π_{c} of a predetermined set of lighting profiles Π. The predetermined set of lighting profiles Π can include one or more lighting profiles that often occur in real-world settings. For example, the predetermined set of lighting profiles Π can include “Incandescent 2700K,” “Fluorescent 2700K,” “Fluorescent 4000K,” “Fluorescent 6500K,” “Outdoor midday sun (6500K),” or any other profiles of interest.

Subsequently, the ST calibration module 316 is configured to combine the images taken by these sensors under the same lighting profile, to generate a combined image Ī_{π}_{_{c}}_{εΠ}(x,y), one for each of the predetermined set of lighting profiles Π. The combination operation can include computing an average of pixels at the same location (x,y) across the images taken by these sensors under the same lighting profile.

Then, the ST calibration module 316 is configured to process the average image Ī_{π}_{_{c}}_{εΠ}(x,y) for each lighting profile to generate a reference correction mesh C_{r,π}_{_{c}}_{εΠ}(w,z) for each one π_{c} of a predetermined set of lighting profiles Π. For example, the ST calibration module 316 is configured to generate a reference correction mesh C_{r,π}_{_{c}}_{εΠ}(w,z) for each one π_{c} of a predetermined set of lighting profiles Π by down-sampling the average image Ī_{π}_{_{c}}_{εΠ}(x,y) and computing an inverse of each of the values in the down-sampled average image Ī_{π}_{_{c}}_{εΠ}(w,z). Since a reference correction mesh C_{r,π}_{_{c}}_{εΠ}(w,z) is generated based on an average image Ī_{π}_{_{c}}_{εΠ}(x,y), the reference correction mesh C_{r,π}_{_{c}}_{εΠ}(w,z) could be used to remove the shading effects of an “average” sensor of the image sensor type for the associated one of the predetermined set of lighting profiles Π. Because the ST calibration module 316 does not need to use an image captured by the image sensor 306, the ST calibration module 314 can perform the above steps in a laboratory setting, independently of the imaging module 302.

Once the ST calibration module 316 generates the one or more reference correction meshes C_{r,π}_{_{c}}_{εΠ}(w,z) for each one π_{c} of a predetermined set of lighting profiles Π, in step 406, the computing system 308 has access to two sets of correction meshes: the per-unit correction mesh C_{i,π}_{ₚ}(w,z) for a specific lighting profile πₚ, and the one or more reference correction meshes C_{r,π}_{_{c}}_{εΠ}(w,z). Subsequently, the PF estimation module 318 can use these sets of correction meshes to generate a prediction function ƒ for the image sensor 306, which is configured to transform the per-unit correction mesh C_{i,π}_{ₚ}(w,z) for a specific lighting profile πₚ to a lighting-adapted correction mesh C̅_{i,π}_{_{D}}(w,z) for the lighting spectrum π_{D} under which an image was taken.

In some embodiments, the prediction function ƒ for the image sensor 306 can depend on the lighting spectrum under which an image was taken. Also, the prediction function ƒ for the image sensor 306 can also depend on the location of the pixel (w,z). Such a light spectrum dependence and a spatial dependence is represented by subscripts π, (w,z): ƒ_{π,(w,z)}.

In some embodiments, the prediction function ƒ for the image sensor 306 can be a linear function, which may be represented as a matrix. In some cases, the matrix can be a 4×4 matrix since each pixel (w,z) of a correction mesh C can include four gain factors: one for each color channel ([Gr, R, G, Gb]). For example, if the correction mesh has a spatial dimension of 9×7, then 63 4×4 transform matrices M_{π,(w,z)} can represent the prediction function ƒ_{π,(w,z)} for a particular light spectrum. As described further below, during run-time, the computing system 308 can apply the transform matrices M_{π}_{_{D}}_{,(w,z)}, associated with the lighting spectrum π_{D} under which an input image was taken, to a corresponding set of gain factors in the per-unit correction mesh C_{i,π}_{ₚ}(w,z) to generate a lighting-adapted correction mesh C̅_{i,π}_{_{D}}(w,z) for the image sensor 306:

C̅_{i,π}_{_{D}}(w,z)=M_{π}_{_{D}}_{,(w,z)}C_{i,π}_{ₚ}(w,z)

In some embodiments, the PF estimation module 318 can generate a transform matrix M_{π}_{_{c}}_{,(w,z)} for π_{c} by finding a matrix M_{π}_{_{c}}_{,(w,z)} that maps the per-unit correction mesh C_{i,π}_{ₚ}(w,z) to a reference correction mesh C_{r,π}_{_{c}}(w,z) for π_{c}. In essence, the transform matrix M_{π}_{_{c}}_{,(w,z)} maps a correction mesh for a specific light profile πₚ to a correction mesh for one of the predetermined set of lighting profiles π_{c} used to characterize a typical image sensor of an image sensor type.

In some embodiments, the PF estimation module 318 can generate a prediction function by modeling a relationship between

the PF estimation module 318 can generate the transform matrix M_{π}_{_{c}}_{,(w,z)} using a least-squares technique:

$${M}_{{π}_{c} , ( w , z )} = {arg min}_{M} \{ {\sum }_{j ∈ J} {\{ ‖ {C}_{r , {π}_{c}} ( w , z ) - {MC}_{j , {π}_{p}} ( w , z ) ‖ \}}^{2} \}$$

where C_{jεJ,π}_{ₚ}(w,z) represents correction meshes for the specific lighting profile πₚ for all sensors j in the sample set J at that grid location (w,z). These per-unit correction meshes C_{jεJ,π}_{ₚ}(w,z) can be generated by an imaging module manufacturer or a manufacturer of an electronic device that embodies the imaging module 302 as a part of step 402. The resulting matrix M_{π}_{_{c}}_{,(w,z)} is a matrix that can adapt the per-unit correction mesh C_{i,π}_{ₚ}(w,z) to a different lighting spectrum π_{c}.

In other embodiments, the PF estimation module 318 can augment the least-squares technique to take into account characteristics of the matrix M:

$${M}_{{π}_{c} , ( w , z )} = {arg min}_{M} \{ {\sum }_{j ∈ J} {\{ ‖ {C}_{r , {π}_{c}} ( w , z ) - {MC}_{j , {π}_{p}} ( w , z ) ‖ \}}^{2} + {‖ M ‖}^{γ} \}$$

where ∥M∥^{γ} is a γ-norm of the matrix M, which can prefer a sparse matrix M compared to a non-sparse matrix.

In other embodiments, the PF estimation module 318 can estimate a non-linear regression function that maps the correction mesh C_{jεJ,π}_{ₚ}(w,z) for the specific lighting profile πₚ to a reference correction mesh C_{r,π}_{_{c}}(w,z):

$${f}_{{π}_{c} , ( w , z )} = {arg min}_{f} \{ {\sum }_{j ∈ J} {\{ ‖ {C}_{r , {π}_{c}} ( w , z ) - f ( {C}_{j , {π}_{p}} ( w , z ) ) ‖ \}}^{2} \}$$

where ƒ can be a parametric function or a non-parametric function, such as a kernel function. In some embodiments, the non-linear function ƒ_{π}_{_{c}}_{,(w,z)} can be estimated using support vector machine techniques, and/or any other supervised learning techniques for regression.

Since the PF estimation module 318 can generate a transform matrix M_{π}_{_{c}}_{,(w,z)} or a non-linear function ƒ_{π}_{_{c}}_{,(w,z)} independently of the grid location (w,z), the PF estimation module 318 can generate a transform matrix M_{π}_{_{c}}_{,(w,z)} or a non-linear function ƒ_{π}_{_{c}}_{,(w,z)} that does not depend on any assumption about the pattern of the shading non-uniformity. Thus, the disclosed technique is highly adaptable to different causes of non-uniformity, and therefore to different types of sensors. Also, since the disclosed scheme uses a 4×4 transform matrix, arbitrary crosstalk among color channels at a given sensor location can be corrected.

Once the PF estimation module 318 computes the prediction function (e.g., the transform matrix M_{π}_{_{c}}_{,(w,z)} or the non-linear function ƒ_{π}_{_{c}}_{,(w,z)}) for each one π_{c} of a predetermined set of lighting profiles Π, the PF estimation module 318 can provide the prediction function to the memory 312 and/or the internal image module memory 322 via the interface 326.

In some embodiments, the prediction function (e.g., the transform matrix M_{π}_{_{c}}_{,(w,z)} or the non-linear function ƒ_{π}_{_{c}}_{,(w,z)}) can be generated independently of the particular sensor of interest. For example, the per-unit correction meshes C_{jεJ,π}_{ₚ}(w,z) does not need to include the per-unit mesh of the particular sensor i of interest. Therefore, the prediction function can be generated once for all image sensors of the image sensor type. As long as an image sensor is typical of an image sensor type, the shading effects in the image sensor can be corrected using the estimated prediction function.

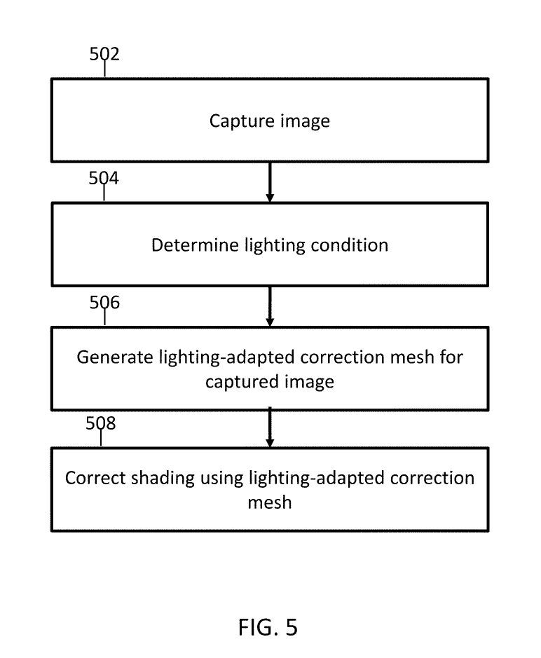

FIG. 5 illustrates a shading correction process during a run-time stage in accordance with some embodiments. In step 502, the image sensor i is configured to capture an image I(x,y) of a scene and provide the captured image I(x,y) to the correction module 320. In step 504, the correction module 320 is configured to estimate a lighting condition (e.g., lighting profile π_{D}) under which the image I(x,y) was taken. In some embodiments, the correction module 320 is configured to use an auto white balance (AWB) technique to determine the lighting profile π_{D}. In other embodiments, the correction module 320 is configured to receive results of an AWB technique, which is performed separately at a separate computing device. In some cases, the AWB technique can select one π_{c} of the predetermined set of lighting profiles Π as the lighting profile π_{D} for the captured image. In other embodiments, the AWB technique can detect mixed lighting conditions in which the lighting profile π_{D} can be represented as a linear combination of two or more of the predetermined set of lighting profiles Π:

$${π}_{D} = {\sum }_{c = 1}^{C} {α}_{c} {π}_{c}$$

In step 506, the correction module 320 is configured to generate a lighting-adapted correction mesh for the captured image. To this end, the correction module 320 is configured to retrieve the per-unit correction mesh C_{i,π}_{ₚ}(w,z) for the particular image sensor i and the prediction function corresponding to the determined lighting profile π_{D}. When the determined lighting profile π_{D} is one π_{c} of the predetermined set of lighting profiles Π, then the correction module 320 can retrieve the prediction function corresponding to the determined lighting profile π_{D} by retrieving the prediction function (e.g., the transform matrix M_{π}_{_{c}}_{,(w,z)} or the non-linear function ƒ_{π}_{_{c}}_{,(w,z)}) for the associated one π_{c} of the predetermined set of lighting profiles Π. When the determined lighting profile π_{D} is a linear combination of the predetermined set of lighting profiles Π, then the correction module 320 can retrieve the prediction function corresponding to the determined lighting profile π_{D} by combining the prediction functions corresponding to the predetermined set of lighting profiles Π. For example, when the prediction functions are transform matrices M_{π}_{_{c}}_{,(w,z)} and the AWB technique provided a set of π_{c} for π_{D}, then the correction module 320 can linearly combine the transform matrices M_{π}_{_{c}}_{,(w,z)} to generate the transform matrix M_{π}_{_{D}}_{,(w,z)} for the determined lighting profile π_{D}:

$${M}_{{π}_{D} , ( w , z )} = {\sum }_{c = 1}^{C} {α}_{c} {M}_{{π}_{c} , ( w , z )}$$

Once the correction module 320 determines the prediction function for the determined lighting profile π_{D}, the correction module 320 can apply the prediction function to the per-unit correction mesh C_{i,π}_{ₚ}(w,z) of the image sensor i to determine the lighting adapted correction mesh C̅_{i,π}_{_{D}}(w,z). For example, when the prediction function is a transform matrix M_{π}_{_{D}}_{,(w,z)}, then the correction module 320 can multiply the transform matrix M_{π}_{_{D}}_{,(w,z)} to the per-unit correction mesh C_{i,π}_{ₚ}(w,z) to determine the lighting-adapted correction mesh C̅_{i,π}_{_{D}}(w,z):

C̅_{i,π}_{_{D}}(w,z)=M_{π}_{_{D}}_{,(w,z)}C_{i,π}_{ₚ}(w,z).

As another example, when the prediction function is a non-linear function ƒ_{π}_{_{c}}_{,(w,z)}, then the correction module 320 can apply the non-linear function ƒ_{π}_{_{c}}_{,(w,z)} to the per-unit correction mesh C_{i,π}_{ₚ}(w,z) to determine the lighting-adapted correction mesh C̅_{i,π}_{_{D}}(w,z):

C̅_{i,π}_{_{D}}(w,z)=ƒ_{π}_{_{D}}_{,(w,z)}(C_{i,π}_{ₚ}(w,z)).

In step 508, the correction module 320 can subsequently use the lighting-adapted correction mesh C̅_{i,π}_{_{D}}(w,z) to remove the shading effect in the image. For example, the correction module 320 can up-sample the lighting-adapted correction mesh C̅_{i,π}_{_{D}}(w,z) to C̅_{i,π}_{_{D}}(x,y) so that the lighting-adapted correction mesh C̅_{i,π}_{_{D}}(x,y) has the same dimension as an input image I(x,y). During this up-sampling process, the correction module 320 can be configured to organize the gain factors for the color channels [Gr, R, G, Gb] in accordance with the Bayer CFA pattern of the input image I(x,y). Then, the correction module 320 can be configured to multiply, in a pixel-by-pixel manner, the lighting-adapted correction mesh C̅_{i,π}_{_{D}}(x,y) and the input image I(x,y) to remove the shading effect on the input image I(x,y).

The disclosed shading correction scheme is effective because it is able to take into account both the sensor-specific characteristics, such as the per-unit correction mesh C_{i,π}_{ₚ}(w,z), and the typical characteristics of sensors having the same image sensor type, such as the reference correction meshes C_{r,π}_{_{c}}(w,z).

In some embodiments, one or more of the modules 314, 316, 318, and 320 can be implemented in software using the memory 312. The memory 312 can be a non-transitory computer readable medium, flash memory, a magnetic disk drive, an optical drive, a programmable read-only memory (PROM), a read-only memory (ROM), or any other memory or combination of memories. The software can run on a processor 310 capable of executing computer instructions or computer code. The processor 310 might also be implemented in hardware using an application specific integrated circuit (ASIC), programmable logic array (PLA), digital signal processor(DSP), field programmable gate array (FPGA), or any other integrated circuit.

In some embodiments, one or more of the modules 314, 316, 318, and 320 can be implemented in hardware using an ASIC, PLA, DSP, FPGA, or any other integrated circuit. In some embodiments, two or more of the modules 314, 316, 318, and 320 can be implemented on the same integrated circuit, such as ASIC, PLA, DSP, or FPGA, thereby forming a system on chip.

In some embodiments, the imaging module 302 and the computing system 308 can reside in a single electronic device. For example, the imaging module 302 and the computing system 308 can reside in a cell phone or a camera device.

In some embodiments, the electronic device can include user equipment. The user equipment can communicate with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The electronic device can also include any platforms capable of computations and communication. Non-limiting examples can include televisions (TVs), video projectors, set-top boxes or set-top units, digital video recorders (DVR), computers, netbooks, laptops, and any other audiovisual equipment with computation capabilities. The electronic device can be configured with one or more processors that process instructions and run software that may be stored in memory. The processor also communicates with the memory and interfaces to communicate with other devices. The processor can be any applicable processor such as a system-on-a-chip that combines a CPU, an application processor, and flash memory. The electronic device may also include speakers and a display device in some embodiments.

In other embodiments, the imaging module 302 and the computing system 308 can reside in different electronic devices. For example, the imaging module 302 can be a part of a camera or a cell phone, and the computing system 308 can be a part of a desktop computer or a server. In some embodiments, the imaging module 302 and the computing system 308 can reside in a single electronic device, but the PU calibration module 314, the ST calibration module 316, and/or the PF estimation module 318 can reside in a separate computing device in communication with the computing system 308, instead of the computing system 308 itself. For example, the PU calibration module 314, the ST calibration module 316, and/or the PF estimation module 318 can reside in a server in a data center.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

We claim:

1. An apparatus configured to remove a shading effect from an image, the apparatus comprising:
one or more interfaces configured to provide communication with an imaging module that is configured to capture the image; and
a processor, in communication with the one or more interfaces, configured to run a module stored in memory that is configured to:
receive the image captured by the imaging module under a first lighting spectrum;
receive a per-unit correction mesh for adjusting images captured by the imaging module under a second lighting spectrum;
determine a correction mesh for the image captured under the first lighting spectrum based on the per-unit correction mesh for the second lighting spectrum; and
operate the correction mesh on the image to remove the shading effect from the image.

2. The apparatus of claim 1, wherein the module is further configured to determine that the image was captured under the first lighting spectrum using an automated white balance technique.

3. The apparatus of claim 2, wherein the module is further configured to determine the correction mesh for the image based on the first lighting spectrum of the image.

4. The apparatus of claim 2, wherein the module is configured to:
determine, using the automated white balance technique, that the first lighting spectrum of the image is substantially similar to one of a predetermined set of lighting spectra,
receive a prediction function associated with the one of the predetermined set of lighting spectra, and
apply the prediction function to at least a portion of the per-unit correction mesh to determine the correction mesh for the image.

5. The apparatus of claim 4, wherein the prediction function comprises a linear function.

6. The apparatus of claim 4, wherein the prediction function is based on characteristics of image sensors having an identical image sensor type as an image sensor in the imaging module.

7. The apparatus of claim 4, wherein the prediction function is associated only with the portion of the per-unit correction mesh.

8. The apparatus of claim 2, wherein the module is configured to:
determine, using the automated white balance technique, that the first lighting spectrum of the image is substantially similar to a linear combination of two or more lighting spectra,
receive prediction functions associated with the two or more lighting spectra,
combine the prediction functions to generate a final prediction function, and
apply the final prediction function to at least a portion of the per-unit correction mesh to determine the correction mesh for the image.

9. The apparatus of claim 1, wherein the apparatus is a part of a camera module in a mobile device.

10. A method for removing a shading effect on an image, the method comprising:
receiving, at a correction module of a computing system, the image captured under a first lighting spectrum from an imaging module over an interface of the computing system;
receiving, at the correction module, a per-unit correction mesh for adjusting images captured by the imaging module under a second lighting spectrum;
determining, at the correction module, a correction mesh for the image captured under the first lighting spectrum based on the per-unit correction mesh for the second lighting spectrum; and
operating, at the correction module, the correction mesh on the image to remove the shading effect from the image.

11. The method of claim 10, further comprising determining that the image was captured under the first lighting spectrum using an automated white balance technique.

12. The method of claim 11, further comprising determining the correction mesh for the image based on the first lighting spectrum of the image.

13. The method of claim 11, further comprising:
determining, using the automated white balance technique, that the first lighting spectrum of the image is substantially similar to one of a predetermined set of lighting spectra,
receiving a prediction function associated with the one of the predetermined set of lighting spectra; and
applying the prediction function to at least a portion of the per-unit correction mesh to determine the correction mesh for the image.

14. The method of claim 13, wherein the prediction function is based on characteristics of image sensors having an identical image sensor type as an image sensor in the imaging module.

15. The method of claim 11, further comprising:
determining, using the automated white balance technique, that the first lighting spectrum of the image is substantially similar to a linear combination of two or more lighting spectra,
receiving prediction functions associated with the two or more lighting spectra,
combining the prediction functions to generate a final prediction function, and
applying the final prediction function to at least a portion of the per-unit correction mesh to determine the correction mesh for the image.

16. A non-transitory computer readable medium having executable instructions associated with a correction module, operable to cause a data processing apparatus to:
receive an image captured under a first lighting spectrum from an imaging module in communication with the data processing apparatus;
retrieve, from a memory device, a per-unit correction mesh for adjusting images captured by the imaging module under a second lighting spectrum;
determine a correction mesh for the image captured under the first lighting spectrum based on the per-unit correction mesh for the second lighting spectrum; and
operate the correction mesh on the image to remove a shading effect from the image.

17. The non-transitory computer readable medium of claim 16, further comprising executable instructions operable to cause the data processing apparatus to determine that the image was captured under the first lighting spectrum using an automated white balance technique.

18. The non-transitory computer readable medium of claim 17, further comprising executable instructions operable to cause the data processing apparatus to determine the correction mesh for the image based on the first lighting spectrum of the image.

19. The non-transitory computer readable medium of claim 17, further comprising executable instructions operable to cause the data processing apparatus to:
receive a prediction function associated with one of a predetermined set of lighting spectra, and
apply the prediction function to at least a portion of the per-unit correction mesh to determine the correction mesh for the image.

20. The non-transitory computer readable medium of claim 17, wherein the prediction function is based on characteristics of image sensors having an identical image sensor type as an image sensor in the imaging module.
